(19) United States
(12) Patent Application Publication
(10) Pub. No.: US 2026/0024215 A1
(43) Pub. Date: Jan. 22, 2026

(54) METHOD FOR TRACKING OBJECT MOVEMENT AND MAPPING A SPACE

(71) Applicant: VergeSense, Inc., San Francisco, CA (US)

(72) Inventor: Kelby Green, San Francisco, CA (US)

(21) Appl. No.: 19/272,189

(22) Filed: Jul. 17, 2025

Related U.S. Application Data
(60) Provisional application No. 63/672,597, filed on Jul. 17, 2024.

(51) Int. Cl. G06T 7/20; G06T 7/13; G06T 7/40; G06T 11/00; G06T 13/80; G06V 10/44; G06V 10/764; G06V 10/774

(52) U.S. Cl. CPC G06T 7/20; G06T 7/13; G06T 7/40; G06T 11/001; G06T 13/80; G06V 10/44; G06V 10/764; G06V 10/774; G06T 2207/10048; G06T 2207/30196; G06T 2207/30232

(57) ABSTRACT

One variation of a method includes, at a first sensor block: capturing an image of a space; detecting a constellation of edges representing objects in the space; assembling the constellation of edges into an edge map; and serving the edge map to a remote computer system. The method includes, at the remote computer system: passing the edge map to a model configured to generate synthetic photographic images of the space based on edge maps; receiving a synthetic photographic image of the space from the model, the synthetic photographic image representing locations of objects in the space; and serving the synthetic photographic image to an operator portal for an operator to view an anonymized layout of the space.

### CROSS-REFERENCE TO RELATED APPLICATIONS

This application claims the benefit of U.S. Provisional Application No. 63/672,597, filed on 17 Jul. 2024, which is incorporated in its entirety by this reference.

This application is related to U.S. Provisional Application No. 63/274,905, filed on 2 Nov. 2021, which is incorporated in its entirety by this reference.

### TECHNICAL FIELD

This invention relates generally to the field of workplace monitoring and, more specifically, to a new and useful method for tracking object movement and mapping a space in the field of workplace monitoring.

### BRIEF DESCRIPTION OF THE FIGURES

FIG. 1 is a flowchart representation of a method;

FIG. 2 is a flowchart representation of one variation of the method;

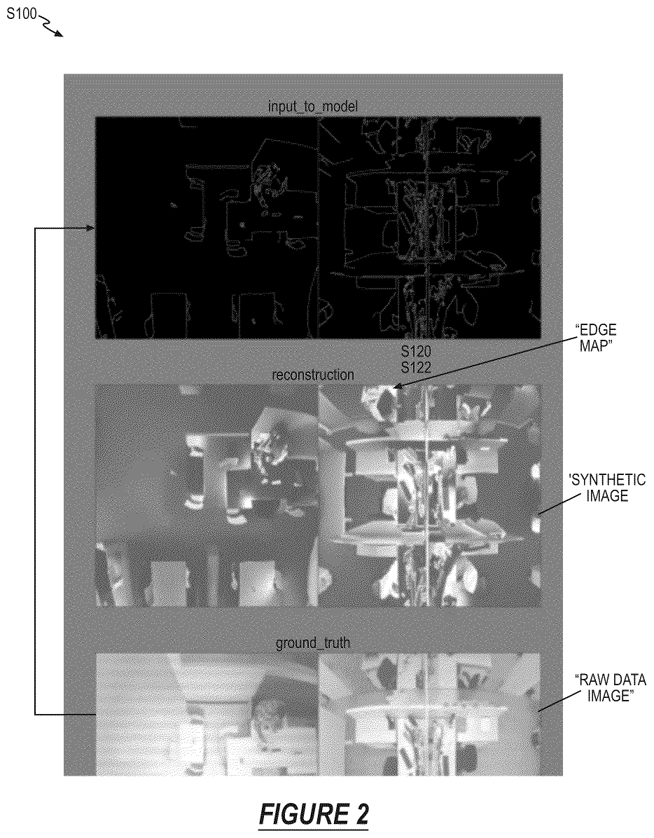

FIG. 3 is a flowchart representation of one variation of the method;

FIG. 4 is a flowchart representation of one variation of the method; and

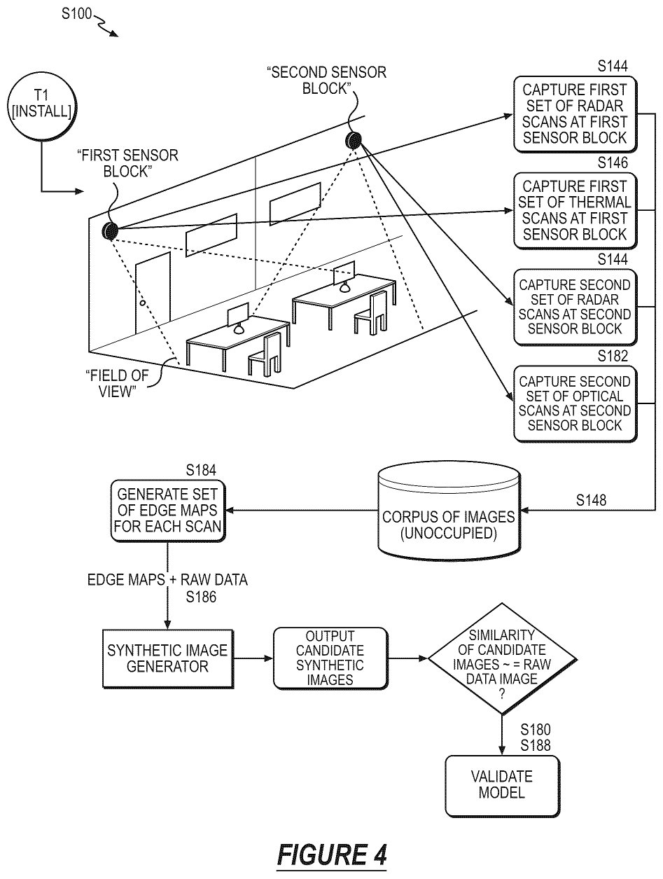

FIG. 5 is a flowchart representation of one variation of the method.

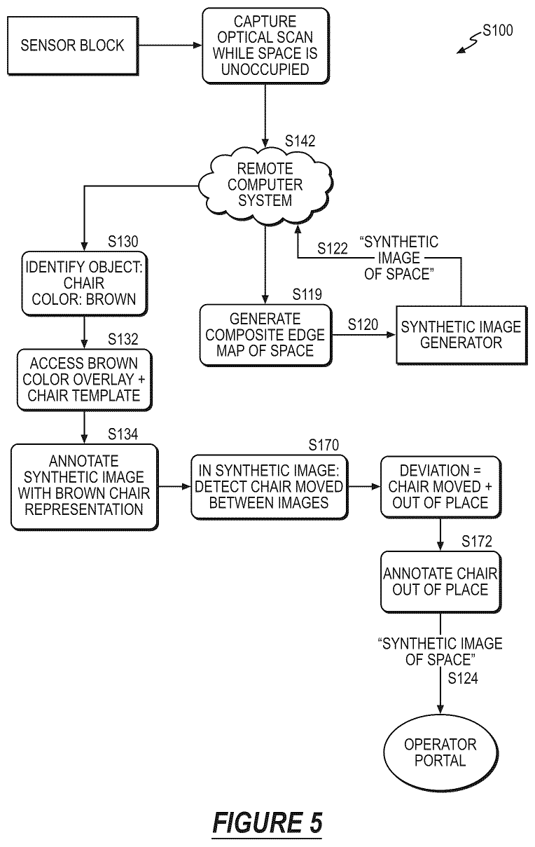

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

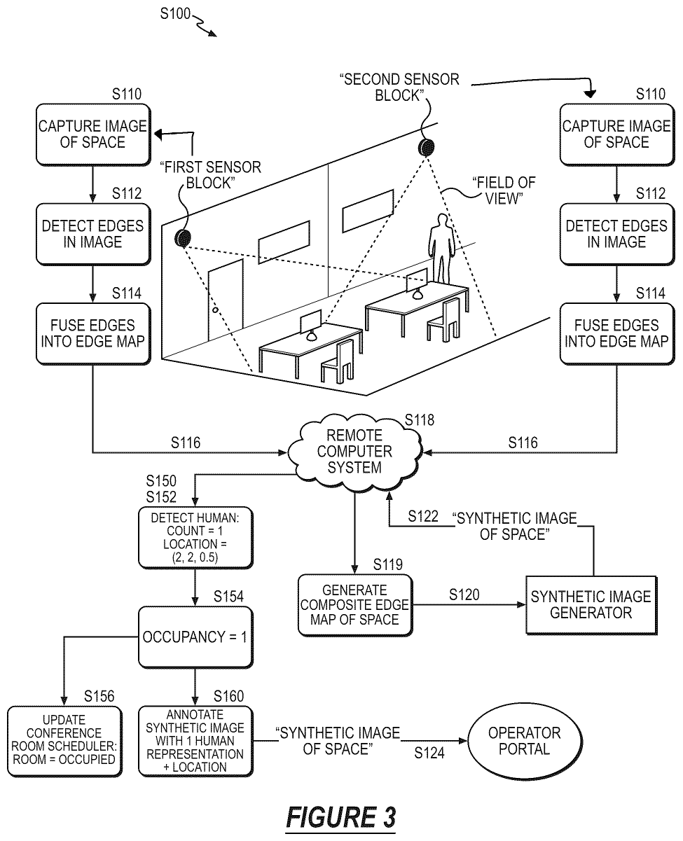

As shown in FIG. 3, a method S100 includes, at a first sensor block: capturing a first image of a space in Block S110; detecting a constellation of edges in the first image, the constellation of edges representing objects in the space in Block S112; assembling the constellation of edges into an edge map in Block S114; and serving the edge map to a remote computer system in Block S116. The method S100 further includes, at the remote computer system and during a first time period: receiving the edge map from the first sensor block in Block S118; passing the edge map to a model configured to transform edge maps into synthetic photographic images representing locations of objects in Block S120; receiving a synthetic photographic image of the space from the model, the synthetic photographic image representing locations of objects in the space in Block S122; and serving the synthetic photographic image to an operator portal for an operator to view an anonymized layout of the space in Block S124.

### 1.1 Variation: Composite Edge Maps

One variation of the method S100 includes, at a first sensor block, in a population of sensor blocks deployed in a space, capturing a first set of images of the space in Block S110, and, for each image in the set of images: detecting a constellation of edges representing edges of objects in the space in Block S112; assembling the constellation of edges into an edge map in a set of edge maps in Block S114; and serving the set of edge maps to a remote computer system in Block S116. This variation of the method S100 further includes, at the remote computer system: assembling the set of edge maps into a composite edge map in Block S119; passing the composite edge map to a model configured to transform edge maps into synthetic photographic images representing locations of objects in Block S120; receiving a synthetic photographic image of the space from the model, the synthetic photographic image representing locations of objects in the space in Block S122; and serving the synthetic photographic image to an operator portal for an operator to view an anonymized layout of the space in Block S124.

### 1.2 Variation: Model-Free Image Generation

One variation of the method S100 includes, at the first sensor block: capturing a first image of a space in Block S110; detecting a constellation of edges in the first image, the constellation of edges representing edges of objects in the space in Block S112; assembling the constellation of images into an edge map in Block S114; and serving the edge map to a remote computer system in Block S116. This variation of the method S100 further includes, at the remote computer system during a first time period: receiving the edge map from the first sensor block in Block S118; generating a synthetic photographic image of the space based on the edge map, the synthetic photographic image representing locations of objects in the space in Block S120; and serving the synthetic photographic image to an operator portal for an operator to view an anonymized layout of the space in Block S124.

### 1.3 Variation: Point Clouds+Human Movement Profiles

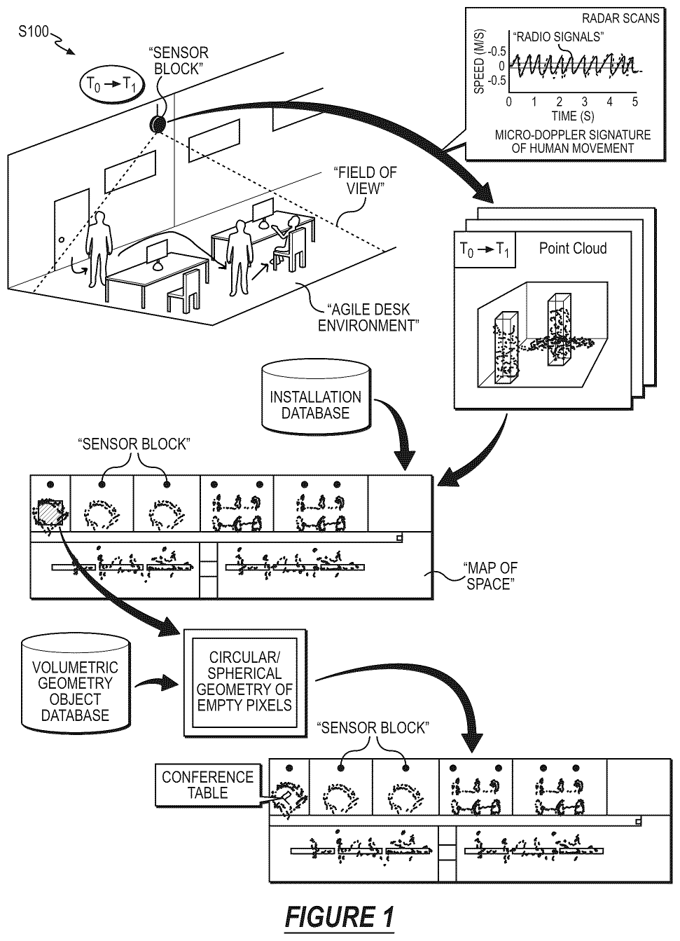

As shown in FIG. 1, a method S100 for tracking object movement and mapping a space includes, during a first time period: accessing a set of point clouds, each point cloud in the set of point clouds representing human movement profiles within regions of the space and generated by a set of sensor blocks deployed in the space; accessing an installation database including installation locations of the set of sensor blocks annotated with regions of the space; and compiling locations, velocities, and orientations of a first set of objects represented in the set of point clouds into a map of the space based on installation locations of the set of sensor blocks.

The method S100 further includes, during a second time period: accessing a set of scans, each scan in the set of scans representing human movement profiles within a first region of the space, generated by a first sensor block in the set of sensor blocks; projecting the set of scans onto the map of the space; detecting a void between human movement profiles in the first region within the map of the space; characterizing a volumetric geometry of the void; in response to the volumetric geometry approximating a volumetric definition of a first furniture object type, in a set of furniture object types, labeling the void with the first furniture object type within the map of the space; retrieving graphical representations of object types from a template graphical representation database; and populating the map of the space with a graphical representation analogous to the first furniture object type, in the set of furniture object types, to generate a furniture layout of the space.

### 1.4 Variation: Floor Plan

One variation of the method S100 includes: accessing a first set of radar scans, each radar scan in the set of radar scans representing human movement profiles within a first region of the space, generated by a first sensor block, in a set of sensor blocks, during a first time period; accessing a second set of radar scans, each radar scan in the second set of radar scans representing human movement profiles within a second region, adjacent the first region, generated by a second sensor block, in the set of sensor blocks, during the first time period; and aggregating the first set of radar scans and the second set of radar scans into a composite radar scan.

This variation of the method S100 further includes: detecting a void between human movement profiles in the first region and the second region in the composite radar scan; characterizing a volumetric geometry of the void; in response to the volumetric geometry approximating a volumetric definition of a first static object type, in a set of static object types, labeling the void with the first static object type within the composite radar scan; retrieving graphical representations of object types from a template graphical representation database; and populating the composite radar scan with a graphical representation analogous to the first static object type, in the set of static object types, to generate a floor plan of the space.

### 2. Applications

Generally, Blocks of the method S100 can be executed by a remote computer system (e.g., a remote server) and/or a local gateway in conjunction with a set of sensor blocks deployed within a space (e.g., an office facility) to: at a first sensor block, generate an anonymized edge map (e.g., binary image) of the space based on edges detected in images collected during an installation time period, such as based on non-optical data (e.g., radar scans, thermal scans, depth scans) collected by the first sensor block; and, at the computer system, receive edge maps generated by the first sensor block, such as excluding personally identifiable information (e.g., optical data) and generate a synthetic photographic image (e.g., optical representation) of the space based on this edge map to thereby enable an operator to view and understand layout and occupancy data for the space while withholding transmission (and/or collection) of personally identifiable information or information that may be reconstructed to be personally identifiable information.

The remote computer system can: receive an edge map (e.g., a vectorized image, non-optical data) including locations of humans detected by a motion sensor (e.g., ultrasonic sensor, thermal sensor, radar sensor, microwave sensor) arranged in each sensor block and annotated with scan data (e.g., locations, orientations, and velocities of humans), compile these scan data, edge map, and stored installation locations of the set of sensor blocks into a synthetic photographic image of the space; detect static objects (e.g., walls, floors, doorways) and mutable objects (e.g., tables, desks, chairs) within the synthetic photographic image; and annotate the synthetic photographic image of the space with human locations such that the synthetic photographic image can represent a predicted furniture layout or a predicted floor plan of the space and occupancy data for the space during the first time. The remote computer system can serve the synthetic photographic image to a user (e.g., an administrator, an office manager of the space), such as via a user portal, and thus enable the user to achieve and maintain awareness of the furniture layout or the floor plan of the space, including anonymized occupancy data, during a current time period or any previous time period.

In particular, a sensor block can: capture a first scan (e.g., optical scan, radar scan) of a space; compress and/or transform the scan into an anonymized non-optical image, such as an edge map including a constellation of edges, representing edges of objects (e.g., desks, chairs, walls, rugs) in the space and excluding personally identifiable information (e.g., facial images, locations of humans in the space, photographs of humans); and transmit the edge map to a remote computer system to thereby prevent transmission and storage of such personally identifiable information.

The remote computer system can: receive the edge map from the sensor block (e.g., via a local gateway); and generate a synthetic photographic image of the space from the edge map and approximating the first scan captured by the sensor block while excluding personally identifiable information. For example, for each object (e.g., desk object, table object, human object) detected in the edge map, the remote computer system can access stored representations of these objects approximating the object geometry, and assemble these stored representations into the synthetic photographic image. Additionally or alternatively, the remote computer system can: interpret an object type of an object detected within the edge map; based on the object type, generate a representation of the object; and assemble the representation of the object into the synthetic photographic image to inject interpreted optical data into the non-optical representation of the space to thereby transform this non-optical data collected by the sensor block and transmitted to the remote computer system into optical data readable by an operator.

Accordingly, the remote computer system and the sensor block can coordinate to augment non-optical data captured by the sensor block into an optical synthetic photographic image of the space representing an anonymized layout of space, and to enable the sensor block to capture scans while space is occupied or while space is unoccupied and prevent collection of personally identifiable information.

Therefore, the remote computer system can execute Blocks of the method S100: to maintain personal privacy (e.g., for employees or customers associated with the space) by capturing initialization images without humans present and recording radar scans when humans are occupying the space to eliminate collecting visually identifiable information about these humans; and to autonomously predict a real-time furniture layout and a floor plan of the space.

In one example, Blocks of the method S100 can be executed by a remote computer system (e.g., a remote server) and/or a local gateway in conjunction with a set of sensor blocks deployed within a space: to receive radar scans representing movement profiles of humans detected by a motion sensor (e.g., ultrasonic sensor, thermal sensor, radar sensor, microwave sensor) arranged in each sensor block and annotated with radar scan data (e.g., locations, orientations, and velocities of humans)—compile these radar scans, radar scan data, and stored installation locations of the set of sensor blocks into a synthetic photographic image of the space; to detect and differentiate between static objects (e.g., walls, floors, doorways) and mutable objects (e.g., tables, desks, chairs) within the map; to annotate these static objects and mutable objects with graphical representations (e.g., a symbol, an icon, a textual identifier); and to generate a visualization of the space representing human movement profiles, a predicted furniture layout, and a predicted floor plan of the space. The remote computer system can serve the visualization to a user (e.g., an administrator, an office manager of the space), such as via a user portal, and thus enable the user to achieve and maintain awareness of the furniture layout and the floor plan of the space during a current time period or any previous time period.

More specifically, each sensor block can: during a scan cycle, transmit radio signals, at a first frequency and within a threshold distance of the sensor block via the radar sensor; during the scan cycle, receive returned radio signals, reflected from objects moving in an agile work environment, at the first frequency via the radar sensor; record time-of-arrival receipts and transmit and returned radio signal pairs; and offload these time-of-arrival receipts and transmit and returned radio signal pairs to the computer system. Accordingly, the remote computer system processes transmit and returned radio signal pairs from each sensor block: to interpret characteristics of each human (e.g., a size, a dimension, a shape) in the region; to derive scan data for this scan cycle, such as a velocity, a direction of motion, a location relative the sensor block, or an orientation of the human relative to the sensor block based on the radio signal pairs; to detect movement profiles of humans within the field of view of the sensor block based on these characteristics; and to generate a map of the space representing movement profiles of humans and annotated with these scan data.

Furthermore, the remote computer system can execute Blocks of the method S100: to access a set of radar scans, representing movement of humans within a particular region of the space and annotated with scan data (e.g., a location, an orientation, a velocity, a direction of motion), from a sensor block during a time period (e.g., one day, one week); to aggregate the set of radar scans into a two-dimensional or three-dimensional point cloud representing movement profiles of humans in the particular region during this time period; to align and overlay the two-dimensional or three-dimensional point cloud of the particular region onto the map of the space; and to identify and annotate gaps within movement profiles of humans in the particular region as furniture object types (e.g., desks, tables, chairs) in the map to predict a furniture layout in the particular region.

For example, the remote computer system can: detect a void—such as a gap corresponding to missing or incomplete data across regions of the space—between movement profiles in an agile desk environment within the map of the space; characterize a geometry of the void, such as a rectangular geometry or a rectangular cuboid geometry; identify the void as a furniture object type, such as a desk, in the agile desk environment according to the geometry; and annotate the void with a graphical representation of a desk in order to predict a furniture layout for the agile desk environment.

Additionally, the remote computer system can: characterize voids between movement profiles as static objects (e.g., a wall, a floor, a doorway, a stairwell) in the map; annotate these voids with graphical representations of static objects in order to autonomously predict a floor plan of the space; and serve a visualization of the space representing human movement profiles, a predicted furniture layout, and a predicted floor plan of the space to a user portal.

The method S100 is described herein as executed by the remote computer system to detect, track, visualize, and manage human movement patterns within a space, such as an office facility or a clinic. However, the remote computer system can similarly execute Blocks of the method S100 to detect, track, visualize, and manage movement profiles of humans within an industrial, educational, municipal, or other setting.

Additionally or alternatively, the remote computer system can execute Blocks of the method S100: to receive scans representing movement profiles of objects from any other type of sensor—such as an ultrasonic sensor, a thermal sensor, an optical sensor, a LIDAR sensor, a two-dimensional infrared array sensor, a depth sensor, or a microwave sensor—arranged in each sensor block and annotated with scan data (e.g., locations, orientations, and velocities of objects); to aggregate these scans into a two-dimensional or three-dimensional object point cloud representing movement profiles of objects; and to generate a map of the space representing movement profiles of objects and annotated with these scan data.

The method S100 is described herein as executed by a remote computer system (e.g., a remote server). However, Blocks of the method S100 can be executed by one or more entities accessing the network, by a local computer system, or by any other computer system—hereinafter a “system.”

### 3. Sensor Block

A sensor block can include: a motion sensor configured to detect motion in or near the field of view of the optical sensor; a processor configured to interpret data from movement recorded by the motion sensor; a wireless communication module configured to wirelessly transmit these data; a battery or wired power supply configured to power the motion sensor, the processor, and the wireless communication module over an extended duration of time (e.g., one year, five years); and an housing configured to contain the motion sensor, the processor, the wireless communication module, and the battery and configured to mount to a surface with the field of view of the motion sensor intersecting a doorway within the facility (e.g., a doorway to a board room, an entrance to a reception region).

The motion sensor can include a passive infrared sensor (or “PIR” sensor) that defines a field of view and that passively outputs a signal representing movement of objects within (or near) the field of view of the motion sensor. The sensor block can: transition from an inactive state to an active state responsive to an output from the motion sensor indicating motion in the field of view of the motion sensor; and trigger the motion sensor to record movement of an object.

In one example, the motion sensor is coupled to a wake interrupt pin on the processor. However, the motion sensor can define any other type of motion sensor and can be coupled to the processor in any other way to trigger the sensor block to enter an image-capture mode, responsive to motion in the field of view of the motion sensor.

In one variation, the motion sensor includes a radar sensor configured to detect presence, locations, velocities, and other characteristics of objects within the field of view of the sensor block. The sensor block can: passively emit radio signals (e.g., a high-frequency sound wave) within a threshold distance of the sensor block via the radar sensor; receive returned radio signals that interacted with an object and scattered back to the sensor block via the radar sensor; and interpret the transmit and returned radio signals pairs as movement of objects (e.g., humans) within a region of the space. The processor can thus fuse data streams from the radar sensor into a radar scan—such as in the form of a two-dimensional or three-dimensional point cloud representing humans in the field of view of the sensor block—per scan cycle. However, the sensor block can include any other type of sensor (e.g., an ultrasonic sensor, a thermal sensor, an optical sensor, a LIDAR sensor, a depth sensor, a two-dimensional infrared sensor, or a microwave sensor) and can fuse data streams from the sensor in any other way.

In another variation, the sensor block also includes: a distance sensor (e.g., a 1D infrared depth sensor); an ambient light sensor; a temperature sensor; an air quality or air pollution sensor; and/or a humidity sensor. However, the sensor block can include any other ambient sensor. In the active state, the sensor block can sample and record data from these sensors and can selectively transmit these data—paired with insights extracted from images recorded by the sensor block—to a local gateway. The sensor block can also include a solar cell or other energy harvester configured to recharge the battery.

In another variation, the sensor block can include: an optical color sensor including an RGB color sensor. In one implementation, the sensor block can: include a threshold sensor; and capture a set of entry events and a set of exit events detected by the threshold sensor.

Generally, sensor blocks in the population of sensor blocks can define a field of view including regions of the space. In particular, a first sensor block can define a first field of view including a first region of the space, and a second sensor block can define a second field of view including a second region of the space. In one example, the second sensor block defines the second field of view encompassing the second region of the space, the second region of the space intersecting the first region of the space. Additionally or alternatively, the second sensor block defines the second field of view encompassing the second region of the space, the second region of the space adjacent to and distinct from the first region of the space.

The processor can locally execute Blocks of the method S100, to selectively wake responsive to an output of the motion sensor, to trigger the optical sensor to record an image, to write various insights extracted from the image, and to then queue the wireless communication module to broadcast these insights to a nearby gateway for distribution to the remote computer system when these insights exhibit certain target conditions or represent certain changes.

The motion sensor, battery, processor, and wireless communication module, etc. can be arranged within a single housing configured to install on a flat surface—such as by adhering or mechanically fastening to a wall or ceiling—with the field of view of the optical sensor facing outwardly from the flat surface and intersecting a region of interest within the space.

However, this “standalone,” “mobile” sensor block can define any other form and can mount to a surface in any other way.

### 3.1 Wired Power & Communications

In one variation, the sensor block includes a receptacle or plug configured to connect to an external power supply within the facility—such as a power-over-Ethernet cable—and sources power for the radar sensor, processor, etc. from this external power supply. In this variation, the sensor block can transmit non-optical data—such as radar scans annotated with locations, orientations, velocities, and directions of motion of objects or radio signal pairs and time-of-arrival receipts—to the remote computer system via this wired connection (i.e., rather than wirelessly transmitting these data to a local gateway).

### 4. Local Gateway

Generally, a local gateway can receive data transmitted from sensor blocks nearby via wireless communication protocol or via a local ad hoc wireless network; and to pass these non-optical data to the remote computer system (e.g., a remote server), such as over a computer network or long-range wireless communication protocol. For example, the gateway can be installed near and connected to a wall electrical outlet and can pass data received from a nearby sensor block to the remote computer system in (near) real-time. Furthermore, multiple gateways can be installed throughout the space and can interface with many sensor blocks installed nearby to collect data from these sensor blocks and to return these data to the computer system.

### 5. Installation: Setup Period

Generally, during installation, each sensor block is installed (or “deployed”) within the space of the facility. A user (e.g., manager, installer, or administrator of the facility) may install each sensor block such that the field of view of the motion sensor arranged in the sensor block encompasses a region (or “subspace”) within the space (e.g., a conference room, an agile desk environment, a hallway). Once a sensor block is installed in a region of the space, the sensor block can record an installation location, a unique identifier (e.g., a UUID, MAC address, IP address, or other wireless address, etc.), and a timestamp of installation and offload these data to the computer system.

In one implementation, the remote computer system can store installation locations, unique identifiers, and timestamps of installation from the set of sensor blocks in a remote database. The remote computer system then implements regression, machine learning, artificial intelligence, and/or other computer vision techniques to manipulate a set of radar scans or point clouds, annotated with locations, orientations, velocities, and object types, generated by the set of sensor blocks during a scan cycle. The computer system: compiles these radar scans or point clouds and stored locations of the set of sensor blocks into a map of the space; updates the map of the space with radar scans or point clouds generated by the set of sensor blocks during additional scan cycles; and predicts a predicted furniture layout and a predicted floor plan of the space based on voids (e.g., gaps) between human movement profiles, as further described below.

### 6. Scan Cycle

Generally, a sensor block can capture images of a space during a scan cycle, such as during a period of unoccupancy of the space and/or while the space is occupied.

In one implementation the sensor block can capture a non-optical image of the space while the space is occupied. In particular, the sensor block can capture a non-optical image of the space while the space is occupied; and transmit the non-optical image of the space to the remote computer system. In this implementation the sensor block can include a radar sensor and capture a radar scan of the space while the space is occupied to avoid collection of personally identifiable information (e.g., facial images).

In one implementation, the sensor block can: include a threshold sensor; detect occupancy of the space based on entry and exit events detected by the threshold sensor; and capture a scan of the space in response to detecting the space as unoccupied.

For example, in this implementation, the sensor block can: access a set of entry events and a set of exit events detected by the threshold sensor; detect absence of occupancy of the space (e.g., based on the set of entry events approximating/equivalent to the set of exit events); and, in response to detecting absence of occupancy of the space, capture a scan of the space with the optical sensor. Additionally or alternatively, the sensor block can: detect occupancy of the space (e.g., based on the set of entry events exceeding the set of exit events); and, in response to detecting human occupancy of the space, capture a scan of the space with the radar sensor to prevent storage of personally identifiable information.

In one example, the sensor block can: include an optical sensor and a radar sensor; selectively scan the space with the optical sensor while the space is unoccupied; and selectively scan the space with the radar sensor while the space is occupied to generate human movement profiles, as described below.

Additionally or alternatively, the sensor block can: include an optical sensor and a depth sensor; selectively scan the space with the optical sensor while the space is unoccupied; and selectively scan the space with the depth sensor while the space is occupied to generate human movement profiles, as described below. Additionally or alternatively, the sensor block can: include an optical sensor and a motion sensor; selectively scan the space with the optical sensor while the space is unoccupied; and selectively scan the space with the motion sensor while the space is occupied to generate human movement profiles, as described below.

Accordingly, in the foregoing implementations, the sensor block can select a scan type for a particular scan cycle of the space based on occupancy of the space. Therefore, in the foregoing implementations, the sensor block can: identify occupancy of the space; in response to detecting the space as unoccupied (e.g., outside of working hours), selectively switch to an optical sensor; and, in response to detecting the space as occupied (e.g., during working hours), selectively switch to an anonymized sensor to thereby avoid collection and/or storage of personally identifiable information (e.g., facial images).

In one implementation, the sensor block can detect motion of objects (e.g., humans, chairs) approximately within a horizontal plane parallel to a ground plane in the region of the space and within the field of view of the motion sensor during a scan cycle. The sensor block can capture radar scans (e.g., millimeter-wave radar scans) to detect human movement within the field of view of the motion sensor; to interpret characteristics of each human (e.g., a size, a dimension, a shape) in the region; and to derive scan data for the scan cycle, such as a velocity, a direction of motion, a location, or an orientation of each human relative to the sensor block.

More specifically, during a scan cycle, the sensor block can capture a set of radar scans of a particular region in the space. Based on the set of radar scans, the sensor block can: detect locations of objects (e.g., (x, y) pixel locations) within a coordinate system of the sensor block; detect orientations of objects relative the motion sensor; track linear motion of objects along an x-axis; track linear motion of objects along a y-axis; and track rotation of objects about a z-axis normal to the horizontal plane, within the field of view of the motion sensor.

In particular, the sensor block can represent linear motion along the x-axis, linear motion along the y-axis, and rotation about the z-axis of an object as a linear velocity in the horizontal plane and an angular velocity about an axis normal to the horizontal plane of the object. Further, the sensor block can: interpret motion of objects as humans entering into, moving through, and exiting from the particular region of the space; derive a set of entry/exit events for the particular region; derive a human count for the particular region (i.e., a predicted quantity of humans occupying the region) based on the set of entry/exit events; and annotate the set of radar scans with scan data. The sensor block can then aggregate the set of radar scans into a point cloud (e.g., a two-dimensional or three-dimensional point cloud) for the scan cycle and transmit the point cloud to the remote computer system upon termination of the scan cycle.

However, the sensor block can implement similar methods and techniques to derive linear and angular velocities of objects in three-dimensional space (i.e., three linear velocities and three angular velocities) and an absolute or relative total velocity of objects accordingly in three-dimensional space.

### 6.1 Edge Derivation+Edge Maps

Generally, the sensor block can down-sample images, such as non-optical scans collected at the sensor block, into binary edge maps of the space and representing edges of objects (e.g., mutable objects, immutable objects, furniture, walls, flooring, humans) in the space. In particular, the sensor block can: detect a constellation of edges in the first image, the constellation of edges representing objects in the space; assemble the constellation of edges into an edge map; and transmit the edge map to a remote computer system.

For example, the sensor block can capture a first image of the space while the space is unoccupied (e.g., at 2:00 a.m., after employees have left). In particular, the sensor block can trigger a monochrome optical sensor and/or depth sensor to capture a single frame of the space, such as including workstations, filing cabinets, and structural columns. The sensor block can then identify clusters of edges representing edges of objects in the space (e.g., desktops, cubicle dividers, drawer faces, vertical edges of stationary printer stand), such as based on contrast in the image. In particular, the sensor block can detect a first edge in response to contrast between a first candidate edge and a first candidate face exceeding a threshold contrast.

The sensor block can then stitch edges in the constellation of edges into an edge map (e.g., a two-dimensional vector overlay), and transmit the edge map to a remote computer system. In one example, the sensor block: serializes the vector data as a vector graphic and transmits the vector graphic via message query telemetry transport over a local office network and/or the local gateway to an operator portal or server.

In one implementation, the sensor block can detect a constellation of edges in an image based on absence of radar data for a particular region of the image. For example, the sensor block can detect a void (or absence of data) for a particular region based on radar data collected by the sensor block during a first time period. The sensor block can then scan the image for edges of objects in the void in the particular region.

In another implementation, the sensor block can generate an edge map including a binary image (e.g., black and white image, bi-level image, 1-bit image) of the space. In this implementation, in response to receiving an edge map, the remote computer system can project the edge map (e.g., the binary image) into a bitplane or any other rectangular bitmap such that each (x,y) coordinate on the edge map can map to a Boolean state, to thereby enable later logical and morphological processing while consuming minimal computational resources.

In one variation, the sensor block can: detect a first subset of edges for a first object; detect a second subset of edges for a second object; detect a first object type of the first object based on the first subset of edges; detect a second object type of the second object based on the second subset of edges; and annotate the first subset of edges with the first object type and the second subset of edges with the second object type.

In this variation, the sensor block can accordingly detect object types, such as wall objects, desk objects, and/or human objects to further prevent transmission of personally identifiable information that may be collected by the sensor block and enable the remote computer system (and/or the model) to identify representations of these object types.

For example, the sensor block can: capture the first image depicting a first wall surface characterized by a first color pattern and a first desk characterized by a first geometry; detect a first subset of edges of the first wall surface; detect a second subset of edges of the first desk; assemble the constellation of edges into the edge map including the first subset of edges and the second subset of edges; interpret a first wall surface object type from the first subset of edges in the edge map; tag the first subset of edges with the first wall surface object type; interpret a first desk object type from the second subset of edges in the edge map; and tag the second subset of edges with the first desk object type.

Additionally or alternatively, the sensor block can: capture the first image of the space depicting a first human characterized by a first geometry; detect a third subset of edges of the first human; and assemble the constellation of edges into the edge map including the third subset of edges.

Accordingly, when the sensor block serves the edge map to the remote computer system, the remote computer system can access object types of objects represented in the edge map.

The method S100 is described herein as executed by a sensor block to detect a constellation of edges and generate an edge map including the constellation of edges to generate an anonymized representation of the space. Additionally or alternatively, Blocks of the method S100 can be executed by a remote computer system or any other computing system connected to the network to receive a set of raw data from the sensor block and generate a vectorized diagram including the constellation of edges to generate an anonymized representation of the space.

### 7. Synthetic Photographic Images

Generally, a remote computer system can generate a synthetic photographic image depicting a floorplan of the space based on an edge map of the space, such as by passing the edge map to a model configured to transform (or “upsample”) edge maps into optical representations of a floorplan.

In particular, the remote computer system can: receive the edge map from the first sensor block; pass the edge map to a model configured to transform edge maps into synthetic photographic images representing locations of objects; receive a synthetic photographic image of the space from the model, the synthetic photographic image representing locations of objects in the space; and serve the synthetic photographic image to an operator portal for an operator to view an anonymized layout of the space. Accordingly, the remote computer system can generate (or receive) anonymized synthetic photographic images depicting a target space that maintains personal privacy (e.g., for employees or customers associated with the space) by capturing images and transforming them into edge maps of the space and excluding any identifiable human information (e.g., faces, bodies).

In one implementation, the remote computer system can: detect a difference between a first synthetic photographic image and a second synthetic photographic image, the difference representing movement of mutable objects in the space (e.g., desks, chairs) in Block S170; and, in response to detecting the difference, prompt an operator to rearrange the space to resolve the difference. In particular, in this implementation, the first sensor block can capture the first image of the space during the first time period. Then, during a second time period succeeding the first time period, the first sensor block can: capture a second (non-optical) image of a space; detect a second constellation of edges in the second image, the second constellation of edges representing objects in the space; assemble the second constellation of edges into a second edge map; and transmit the second edge map to the remote computer system. Then, the remote computer system can: receive the second edge map; generate a second synthetic photographic image of the space—such as based on executing a model configured to transform edge maps and non-optical data into synthetic photographic optical images—based on the second edge map, the second synthetic photographic image representing locations of objects in the space; detect a difference between the first synthetic photographic image and the second synthetic photographic image in Block S170; annotate the second synthetic photographic image with the difference between the first synthetic photographic image and the second synthetic photographic image in Block S172; and serve the second synthetic photographic image to the operator portal for the operator to view differences in layout of the space from the first time to the second time.

Accordingly, in this example, the remote computer system can detect a difference between a first synthetic photographic image, generated for a first time window, and a second synthetic photographic image, generated for a second time window, thereby characterizing the difference as a floorplan change and/or characterizing an object, associated with the deviation, as out of place and prompting an operator to resolve the difference.

In one implementation, the remote computer system can: access a set of edge maps generated by a set (e.g., pair) of sensor blocks; fuse these edge maps into a composite edge map; and generate a composite synthetic photographic image, representing a set (e.g., two) of regions in the space.

In particular, in this implementation, the remote computer system can: capture the first image depicting a first region (e.g., a conference room, a workstation) of the space; detect the constellation of edges representing objects in the first region of the space; and receive the synthetic photographic image representing locations of objects in the first region of the space. A second sensor block, collocated with the first sensor block, can: capture a second image depicting a second region (e.g., intersecting the first region, adjacent to and distinct from the first region) of the space; detect a second constellation of edges in the second image, the second constellation of edges representing objects in the second region of the space; assemble the second constellation of edges into a second edge map; and transmit the second edge map to the remote computer system. The remote computer system can, during the first time period: receive the second edge map from the second sensor block; pass the second edge map to the model; and receive a second synthetic photographic image of the second region space from the model, the second synthetic photographic image representing locations of objects in the second region of the space.

The remote computer system can then, based on locations of the first sensor block and the second sensor block, assemble the first synthetic photographic image and the second synthetic photographic image into a composite synthetic photographic image representing objects in the first region and the second region of the space.

For example, the remote computer system can: access a first location of the first sensor block; access a second location of the second sensor block; access a first field of view associated with the first location; access a second field of view associated with the second location; and assemble the first synthetic photographic image and the second synthetic photographic image into the composite image based on the first field of view and the second field of view.

Additionally or alternatively, the remote computer system can assemble the first synthetic photographic image and the second synthetic photographic image based on similarities of features in the first synthetic photographic image and the second synthetic photographic image. For example, the remote computer system can assemble the first synthetic photographic image and the second synthetic photographic image into the composite image based on detecting a first desk in the first synthetic photographic image and detecting the first desk in the second synthetic photographic image.

In response to generation of the composite synthetic photographic image, the remote computer system can serve the composite synthetic photographic image to the operator portal for the operator to view an anonymized layout of the first region and the second region of the space.

In one example, the first sensor block can define a first field of view including a first region of the space, and the second sensor block can define a second field of view including a second region of the space, the second region intersecting the first region of the space. In another example, the first sensor block can define a first field of view including a first region of the space, and the second sensor block can define a second field of view including a second region of the space, the second region adjacent to and distinct from the first region of the space.

In this example, the remote computer system can generate the composite synthetic photographic image representing an isometric and/or three-dimensional representation of the space. In particular, the remote computer system can assemble the first synthetic photographic image and the second synthetic photographic image into the composite synthetic photographic image including a three-dimensional isometric view of the space.

Therefore, in the foregoing examples, the remote computer system can coordinate with a population of sensor blocks deployed in a space to generate composite (e.g., three-dimensional) synthetic photographic images of the space according to fields of view of these sensor blocks in the population of sensor blocks.

The method S100 is described herein as executed by a remote computer system to: pass edge maps to a model to generate synthetic photographic images of the space. Additionally or alternatively, the remote computer system can generate the synthetic photographic image based on the edge map. In particular, the remote computer system can: vectorize the edge map based on grouping connected segments into closed contours; classify vectors based on geometric features (aspect ratio, parallelism, size) according to a database of shape templates (e.g., “desk,” “chair,” “rug,” “wall,”); instantiate three-dimensional renderings of these geometric features according to vector locations; and assemble these three-dimensional renderings into a synthetic photographic image of the space, the synthetic photographic image representing a floorplan and/or an instantiation of the space.

### 7.1 Model Generation

Generally, the computer system can: generate and/or access a model configured to generate floorplan images of a space based on edge maps, or contour images, of the space in Block S180. In particular, the computer system can generate the model based on a corpus of images, captured by a population of sensor blocks deployed in the space (and/or multiple spaces) during an installation period, such as during a period of inoccupation of the space.

In one implementation, the first sensor block can capture a corpus of training images of the space (e.g., over an extended time period) in Block S182. The first sensor block can then, for each image in the set of training images: detect a second constellation of edges representing objects in the space; assemble the second constellation of edges into a training edge map in a set of training edge maps in Block S184; and transmit the set of training edge maps and the set of training images to the remote computer system. Then, the remote computer system can: receive the set of training edge maps and the set of training images from the first sensor block; pass the set of training edge maps, the set of training images, and a prompt to generate synthetic photographic images, for each training image in the set of training images and based on a corresponding edge map, to a model in Block S186; validate the model as described below in Block S188; and, in response to validation of synthetic photographic images received from the model, store the model for later implementation (e.g., execution).

Additionally or alternatively, the remote computer system can: pass edge maps, raw data images, and a prompt to transform the edge maps to approximate the raw data image to a model (e.g., training model); receive a candidate synthetic photographic image from the model; calculate a similarity score (e.g., MSE, SSIM, perceptual loss) representing similarity of the synthetic photographic image to the raw data image; and validate the model based on the similarity score exceeding a threshold similarity score.

In one example, during an installation setup period, the sensor block can: capture a corpus of images, such as representing an office space, a conference room, and/or a set of workstations including a set of office furniture (e.g., desks, chairs, cabinets, walls, carpet); and, for each image in the corpus of images, implement object and/or edge detection to detect a constellation of edges of (or mutable) objects in the space (e.g., edges of desks, door frames, monitors). The sensor block can then assemble the constellation of edges into an edge map and store the edge map in a set of edge maps. The sensor block can then transmit the set of edge maps and the corpus of images to a remote computer system. The remote computer system can then: receive the set of edge maps and the corpus of images; select pairs of images and corresponding edge maps; and pass these pairs and a prompt to “reconstruct” or otherwise transform the edge map into a synthetic photographic image into a training model. The computer system can then receive synthetic photographic images generated by the model by mapping edges to visual elements (e.g., desk surfaces, shadows, lighting, contrast, furniture sizes). The remote computer system can then: validate synthetic photographic images received from the training model (e.g., calculating confidence scores, calculating similarity scores); and, in response to validation of synthetic photographic images by the remote computer system, generate (or validate) the model based on the training model.

In one implementation, the remote computer system can: select a first subset of pairs of images and edge maps; assign the first subset of pairs to a training dataset; select a second subset of pairs of images and edge maps, a count of pairs in the second subset falling below a count pairs in the first subset; and assign the second subset of pairs to a testing dataset.

In one implementation, the sensor block can capture a corpus of images during an installation period and including: a set of radar scans; a set of optical images; and/or a set of depth images.

Accordingly, the remote computer system can generate and/or validate the model based on training data collected during an installation period for a population of sensor blocks deployed in a space, such as prior to occupancy of the space.

### 7.2 Anonymized Floorplan Generation+Image Augmentation

In one implementation, the remote computer system can augment a synthetic photographic image of the space with patterns, colors, or other characteristics of the space; and transmit an augmented synthetic photographic image to the operator to enable the operator to view a context-enriched representation of the space.

In this implementation, the remote computer system can: interpret object types based on edge map geometry and/or subsets of edges in the edge map; access stored representations of these object types; and assemble these representations into the synthetic photographic image.

In particular, in this implementation, the remote computer system can: receive an edge map from the sensor block; interpret a first wall surface object from a first subset of edges in the edge map; retrieve a stored wall surface pattern associated with wall surface objects and approximating the first color pattern; generate a first synthetic photographic representation of the first wall surface object characterized by the stored wall surface pattern; interpret a first desk object from a second subset of edges in the edge map; retrieve a stored desk geometry associated with desk objects and approximating the first geometry; and assemble the first synthetic photographic representation of the wall surface object and the second synthetic photographic representation of the first desk object into the synthetic photographic image.

Additionally or alternatively, the remote computer system can: interpret a first wall surface object from the first subset of edges in the edge map; generate a first synthetic photographic representation of the first wall surface object characterized by a second color pattern different from the first color pattern; interpret a first desk object from the second subset of edges in the edge map; generate a second synthetic photographic representation of the first desk object characterized by a second geometry different from the first geometry; and assemble the first synthetic photographic representation of the wall surface object and the second synthetic photographic representation of the first desk object into the synthetic photographic image.

In the foregoing implementation, the remote computer system can additionally or alternatively: interpret a first human object from the third subset of edges in the edge map; generate a third synthetic photographic representation of the first human object characterized by a fourth geometry different from the third geometry; and assemble the third synthetic photographic representation of the first human into the synthetic photographic image.

Accordingly, in the foregoing implementations, the remote computer system can: identify object types of objects—such as humans—in the non-optical edge map; access and/or generate representations of these object types; and assemble these representations into the synthetic photographic representation to generate an anonymized, optical representation of the space.

For example, the remote computer system can: detect a pattern in a first image (e.g., color image) of the space; access a virtual representation of the pattern; and project the virtual representation of the pattern onto the synthetic photographic image.

In particular, the remote computer system can, for a first feature in the first image: identify an object type of the first feature in Block S130; access a pattern overlay based on the object type of the first feature in Block S132; identify the first feature in the synthetic photographic image; project the pattern overlay onto the first feature in the synthetic photographic image in Block S134; and serve the synthetic photographic image, annotated with the pattern overlay, to the operator portal.

In one implementation, the first sensor block can: detect a set of textures in a first image in the set of images; assemble the set of textures into a texture map; and serve the texture map to the remote computer system. The remote computer system can then transform the texture map into the synthetic photographic image representing textures of objects within a field of view of the first sensor block.

For example, the first sensor block can implement methods and techniques described herein to derive a first edge map from non-optical data captured by the sensor block; detect a set of textures and/or color patterns in optical images captured by the sensor block; represent the set of textures in a texture map including texture representations and locations; and serve the texture map and the edge map to the remote computer system. The remote computer system (e.g., at the model) can then: execute a model to transform the texture map and the edge map into a two-dimensional synthetic photographic image representing positions, object types, and object textures of objects within a field of view of the first sensor block.

In a similar example, the remote computer system can: access a pattern of the object from the first image; identify a location (e.g., range of pixels) associated with the pattern based on the first image; and project the pattern, according to the location, onto the synthetic photographic image.

In one example, the remote computer system can: identify a first object within the space; and identify a first object type (e.g., carpet, wallpaper) of the first object, such as based on a relative location of the first object (e.g., on the floor, on a wall).

In a similar implementation, the remote computer system can: identify a first object of a first object type in the synthetic photographic image; access a graphical representation of the first object type (e.g., from a graphical representation database); identify a first location of the first object in the synthetic photographic image; and project the graphical representation of the object onto the synthetic photographic image at the first location.

Additionally or alternatively, the remote computer system can: identify a first object of a first object type in the edge map; access a graphical representation of the first object type (e.g., from a graphical representation database); identify a first location of the first object in the edge map; and project the graphical representation of the object onto the synthetic photographic image according to the first location.

In a similar implementation, the remote computer system can: access a set of colors of a first image of the space (e.g., an initialization image captured while the space is unoccupied) in Block S130; for each color in the set of colors, detect a color location (or color location range); map these color locations in the first image to locations in the first synthetic photographic image; and accordingly project the set of colors onto the synthetic photographic image to generate a colorized synthetic photographic image of the space in Block S134.

In particular, in this implementation, a second sensor block can: include an optical sensor; capture a second optical image of the space while the space is not occupied; and transmit the second image to the remote computer system. The remote computer system can: extract a set of colors from the second image; project the set of colors onto the synthetic photographic image, such as according to locations of the set of colors in the second image; and serve the synthetic photographic image, annotated with the set of colors, to the operator portal.

In one example, the remote computer system can receive the synthetic photographic image including a two-dimensional synthetic photographic image of the space. In this example, the first sensor block can serve a first image to the remote computer system, or any other image captured by an optical sensor arranged on the first sensor block and depicting the space (or a target region of the space), such as while the space is unoccupied and/or during an installation period. The remote computer system can, for a first feature in the first image: identify a color of the first feature; identify the first feature in the synthetic photographic image; project the color onto the first feature in the synthetic photographic image; and serve the two-dimensional synthetic photographic image, annotated with the color, to the operator portal.

Accordingly, in the foregoing example, the remote computer system can: extract colors of features in raw image data; detect locations (e.g., pixel locations) of these colors; and map the colors of features (or approximations of these colors) onto a synthetic photographic image, generated from the raw image data of the space, to augment and contextualize an operator perception of the space.

In another implementation, the remote computer system can generate the synthetic photographic image of the space representing a field of view (or perspective) of the sensor block, such as an overhead view, a planar view, an isometric view, an orthographic view, etc.

For example, the remote computer system can receive the synthetic photographic image including the synthetic photographic image of the space representing a perspective projection. In response to receiving a first image (e.g., a color image captured by an optical sensor) from the first sensor block, the remote computer system can, for a first feature in the first image: identify a color of the first feature; identify the first feature in the synthetic photographic image; project the color onto the first feature in the synthetic photographic image; and serve the synthetic photographic image, representing the perspective projection and annotated with the color, to the operator portal.

In another example, the remote computer system can receive the synthetic photographic image including a two-dimensional synthetic photographic image of the space representing a perspective projection. In response to receiving a first image from the first sensor block, the remote computer system can, for a first feature in the first image: identify a color of the first feature; identify the first feature in the synthetic photographic image; project the color onto the first feature in the synthetic photographic image; and serve the two-dimensional synthetic photographic image, representing the perspective projection and annotated with the color, to the operator portal.

In yet another implementation, the remote computer system can: access a database of graphical representations of objects; and project graphical representations of objects onto the synthetic photographic image. In particular, the remote computer system can: identify object types of objects in the synthetic photographic image, such as based on dimensional (e.g., size) approximations and/or locations within the space; access a database of graphical representations of object types; extract graphical representations of furniture object types (e.g., chair, table, desk) from the database; match the graphical representations of furniture objects types to the corresponding object type label within the synthetic photographic image of the space; and project the graphical representations of furniture objects onto the synthetic photographic image of the space according to locations of these objects within the first image and the first synthetic photographic image.

For example, the remote computer system can: define a database of template graphical representations (e.g., graphics, symbols, icons) associated with furniture object types (e.g., a chair, a desk, a table) and static object types (e.g., a wall, a floor, a doorway); select a furniture object type graphical representation, such as a desk from the database; arrange and locate the desk graphical representation on pixels labeled “desk” in the synthetic photographic image of the space; select a furniture object type graphical representation, such as a table, from the database; arrange and locate the table graphical representation on pixels labeled “table” in the synthetic photographic image of the space; select a static object type graphical representation, such as a wall, from the database; arrange and locate the wall graphical representation all pixels labeled “wall” in the synthetic photographic image of the space; and serve the augmented synthetic photographic image to a user portal.

Accordingly, in the foregoing implementations, the remote computer system can augment synthetic photographic images with contextual data from raw images, such as color, graphical representations of objects, perspectives, and/or dimensional data to thereby augment and contextualize an operator perception of the space via the synthetic photographic image.

### 7.2.1 Variation: Autonomous Floor Plan+Furniture Layout+Visualization

Generally, the remote computer system can access a set of point clouds—annotated with locations, velocities, and orientations of a set of humans—generated by the set of sensor blocks during a scan cycle and compile the set of point clouds into a map of the space. The remote computer system can then: access a next set of point clouds generated by the set of sensor blocks during a next scan cycle; and align and superimpose this next set of point clouds onto the map of the space to generate a real-time visualization of human movement patterns in the space.

In one implementation, the remote computer system can: detect gaps between human movement profiles within a particular region of the space represented in the map; characterize a geometry of the gap based on locations of humans proximal the gap (e.g., within a threshold distance of, nearby); and label the gap as a mutable object (e.g., a table, a desk, a chair) or a static object (e.g., a wall, a floor, a doorway) according to the geometry to predict a furniture layout and/or a floor plan in this particular region. Further, the remote computer system can access a database of volumetric definitions of objects (e.g., static objects, mutable objects) predefined by a user during the setup period. In particular, the user may: define a first volumetric definition of a conference table as a circular or spherical geometry; and define a second volumetric definition of a desk as a rectangular or rectangular cuboid geometry, etc.

In one example, the computer system: detects a void—representing incomplete or missing data—between human movement profiles in a region of the map representative of a conference room; characterizes a volumetric geometry, such as spherical, of the void; and, in response to the volumetric geometry approximating (e.g., matching, corresponding to) a volumetric definition of a conference table, labels the void as a conference table within the map of the space to predict a furniture layout of the space.

In another example, the computer system: detects a void between human movement profiles in a first agile desk environment and a second agile desk environment represented in the map; characterizes a volumetric geometry of the void; and, in response to the volumetric geometry approximating a volumetric definition of a wall, labels the void as a wall within the map of the space to predicate a floor plan of the space.

Furthermore, the remote computer system can: generate a visualization of the space representing human movement profiles, a predicted furniture layout, and a predicted floor plan of the space; and serve the visualization to a user (e.g., an administrator, an office manager of the space) via the user portal. The remote computer system can further generate a selectable timeline slider—accessible by a user at the user portal—to enable the user to search for object type labels, locations, orientations, and velocities and to timely review the predicted furniture layout and/or floor plan of the space during a particular time period or scan cycle of interest to the user.

For example, the remote computer system can generate a real-time visualization of the space including composite radar scans or point clouds captured during a period of time (e.g., three hours, one day, one week, one month, one year) by the set of sensor blocks. The remote computer system can interface with the user portal to receive selection, from a user, to display a real-time visualization of the predicted furniture layout for a particular time period (e.g., between 9 AM and 11 AM) on a particular day of the week (e.g., Wednesday). The remote computer system can then render the real-time visualization of the predicted furniture layout during 9 AM to 11 AM on Wednesday within the user portal for review by the user.

Therefore, the remote computer system can generate a real-time visualization representing human movement profiles, the predicted furniture layout, and the predicted floor plan of the space and serve the real-time visualization to the user portal, thereby providing the user with an automatically up-to-date visualization of the human movement patterns in the space during any current or past time period. Additionally, the remote computer system can present a selectable timeline slider for the visualization to enable a user to search for object type labels, locations, orientations, and dimensions during a particular time period of interest to the user via the user portal.

### 7.2.2 Variation: Graphical Representations+Augmented Floor Plan

In one variation, the remote computer system annotates the predicted floor plan of the space with graphical representations from a database and generates a two-dimensional or three-dimensional augmented map depicting human movement, the furniture layout, and the predicted floor plan of the space.

Furthermore, the remote computer system can: access a database of graphical representations of object types; extract graphical representations of furniture object types (e.g., chair, table, desk) from the database; match the graphical representations of furniture object types to the corresponding object type label within the predicted floor plan of the space; and generate an augmented visualization of human movement patterns in the space and the floor plan of the space over a period of time (e.g., six hours, one day).

For example, the remote computer system can: access a database of template graphical representations (e.g., graphics, symbols, icons) associated with furniture object types (e.g., a chair, a desk, a table) and static object types (e.g., a wall, a floor, a doorway); select a furniture object type graphical representation, such as a desk from the database; arrange and locate the desk graphical representation on top of all pixels labeled “desk” in the predicted floor plan of the space; select a furniture object type graphical representation, such as a table, from the database; arrange and locate the table graphical representation on top of all pixels labeled “table” in the predicted floor plan of the space; select a static object type graphical representation, such as a wall, from the database; arrange and locate the wall graphical representation on top of all pixels labeled “wall” in the predicted floor plan of the space; and serve the augmented floor plan to a user portal.

### 7.2.2 Variation: Object Detection+Point Clouds

Generally, each sensor block can: broadcast radio signals, receive returned radio signals, record transmit and receive durations (e.g., time-of-arrival receipts) for these radio signals, classify an object type of each object moving in a region of the space, and aggregate these radar scan data into a two-dimensional (or three-dimensional) point cloud for the first scan cycle. Accordingly, the remote computer system can: access these point clouds from the set of sensor blocks; transform time-of-arrival receipts into distances between each sensor block and objects moving in the space; and derive locations of objects moving in the space.

In one implementation, a sensor block: broadcasts radio signal pulses at a frame rate, such as between 1 Hz and 20 Hz, during a scan cycle via the radar sensor arranged in the sensor block; records transmit and receive durations of returned radio signals (e.g., radio signals scattered from interaction with an object) representing movement of objects within a region of the space encompassed by the field of view of the radar sensor; implements object classification techniques to classify an object type of each object (e.g., a human object type, a non-human object type); derives locations (e.g., (x, y) pixel locations) within a coordinate system of the sensor block; aggregates locations, transmit durations, receive durations, and object types into a two-dimensional or three-dimensional point cloud of the region of the space during this period of time; and transmits the two-dimensional or three-dimensional point cloud of the region of the space to the computer system.

The computer system: accesses an installation database representing (x, y) locations of the set of sensor blocks deployed in the space; transforms transmit durations, receive durations, and a stored (x, y) location of the sensor block into time-based distances of objects represented in the two-dimensional or three-dimensional point cloud; and derives (x, y) locations of these objects within a global coordinate system of the space corresponding to the coordinate system of the sensor block.

The remote computer system can repeat for each other time period and each other sensor block to aggregate two-dimensional or three-dimensional point clouds and stored locations of the set of sensor blocks into a map of the space.

### 7.2 Mutable Object Detection

In one variation, the sensor block passively transmits radio signals, such as a radio signal pulse once per ten seconds or once per 30 seconds, at a particular frequency and receives reflected radio signals via the spatial sensor arranged in the sensor block. The sensor block then offloads transmit and returned radio signal pairs to the computer system. Accordingly, the remote computer system processes transmit and receive radio signal pairs from the sensor block: to detect human movement within the field of view of the sensor block; to interpret characteristics of each human (e.g., a size, a dimension, a shape) in the region; and to derive scan data for this scan cycle, such as a velocity, a direction of motion, a location of each human relative to the sensor block, or an orientation of each human relative to the sensor block.

For example, the sensor block can: emit a pulse, such as a transmit radio signal, at a first frequency and within a threshold distance of the sensor block via the spatial sensor; receive a return radio signal, reflected from an object within the region, at a second frequency different from the first frequency via the radar sensor; record a transmit duration and a receive duration for the radio signal, such as a time-of-arrival receipt; and offload this transmit and return radio signal pair, and the time-of-arrival receipt to the computer system.

The remote computer system can then: detect a difference (e.g., a Doppler shift) between the first frequency of the transmit radio signal and the second frequency of the return radio signal; calculate a velocity of the object based on the difference between the first frequency of the transmit radio signal and the second frequency of the return radio signal; and, in response to the velocity falling within a target velocity range associated with human movement, identify the object as a human moving in the region within the field of view of the radar sensor. The remote computer system can further: access an installation database representing locations, orientations, and unique identifiers of the set of sensor blocks deployed throughout the space; retrieve a stored location of the sensor block associated with the unique identifier of this sensor block from the installation database; transform the time-of-arrival receipt into a time-based distance between the stored location of the sensor block and the human; and predict an (x, y) location of the human within the region based on the time-based distance and the stored location of the sensor block.

The remote computer system can repeat these methods and techniques for each other transmit and returned radio signal pair and for each other sensor block to aggregate a total matrix (e.g., a table, a list, a chart) of radio signals, durations, velocities, and (x, y) locations for each sensor block. The remote computer system can then derive a timeseries movement profile of each human in the space, as further described below.

Additionally or alternatively, the sensor block can: detect a difference (e.g., a Doppler shift) between the first frequency of the transmit radio signal and the second frequency of the return radio signal; calculate a velocity of the object based on the difference between the first frequency of the transmit radio signal and the second frequency of the return radio signal; and, in response to the velocity falling within a target velocity range associated with human movement, identify the object as a human moving in the region within the field of view of the radar sensor. Further, the sensor block can: transform the time-of-arrival receipt into a time-based distance between the stored location of the sensor block and the human; and predict a (x, y) location of the human within the region relative to the stored location of the sensor block based on the time-based distance.

The sensor block can repeat these methods and techniques for each other transmit and returned radio signal pair to generate a set of radar scans, representing movement profiles of humans within the field of view of the sensor block and annotated with (x, y) locations, frequencies, and velocities, for this scan cycle.

### 7.2.1 Human Movement Profiles+Locations

Generally, during a scan cycle, each sensor block (or the computer system) can implement regression, machine learning, artificial intelligence, and/or other computer vision techniques to track an individual object across multiple (radar) scans and derive a movement profile and/or location of the object in a particular region of the space.

In one implementation, the remote computer system can: receive a second image (e.g., radar scan) of the space in Block S142; derive a set of locations of humans in the space based on representations of humans in the second image in Block S150; access the synthetic photographic image of the space; annotate the synthetic photographic image of the space with the set of locations of humans in the space to generate an anonymized synthetic photographic image representing occupancy of the space in Block S160; and transmit the anonymized synthetic photographic image of the space to the operator portal. For example, the sensor block can: capture a series of radar scans; interpret a set of paths of humans moving within the space from the series of radar scans; and serve the set of paths to the remote computer system. The remote computer system can then: overlay the set of paths onto the synthetic photographic image to generate an anonymized synthetic occupancy animation; and serve the anonymized synthetic occupancy animation to the operator portal.

Additionally or alternatively, the sensor block can: capture a series of thermal scans; interpret a set of paths of humans moving within the space from the series of thermal scans; and serve the set of paths to the remote computer system. The remote computer system can then: overlay the set of paths onto the synthetic photographic image to generate an anonymized synthetic occupancy animation; and serve the anonymized synthetic occupancy animation to the operator portal.

In particular, the remote computer system can assemble the series of radar (or thermal) scans into an animation of the space, such as by stitching consecutive scans together as frames in the animation; and annotate each scan with locations of humans—without including optical data for these humans—to thereby generate the anonymized synthetic occupancy animation representing movement (e.g., pathways) of humans throughout the space.

In another implementation, the sensor block can generate a set of radar scans at the second sensor block including a radar sensor block in Block S144; derive a set of human movement profiles from the set of radar scans in Block S152; and aggregate the set of radar scans into the second image including a composite radar scan in Block S148. In response to receiving the composite radar scan, the remote computer system can derive the set of locations of humans based on the set of human movement profiles in Block S150.

In particular, in this example, the sensor block can capture a set of radar scans of the space over a target time period (e.g., one hour, one day), each radar scan defining a radar data block and including radar metadata (e.g., depth, range, radial velocity). For the set of radar scans, the sensor block can derive a set of human movement profiles from the set of radar scans. In particular, the sensor block can, for each scan in the set of radar scans: identify a set of discrete entities in the scan; for each entity in the set of discrete entities, identify a motion vector indicating a location, a direction, and/or speed of the discrete entity; and identify the entity as a human in the space.

The sensor block can: implement methods and techniques described herein to identify a set of humans in the space; identify a count of humans in the space based on the set of humans; and derive an occupancy of the space based on the count of humans. For example, in response to the count of humans falling below a threshold count (e.g., “0”), the sensor block can identify the space as unoccupied and/or available. Additionally or alternatively, in response to the count of humans exceeding a threshold count (e.g., “3”), the sensor block can identify the space as occupied and/or unavailable.

Additionally or alternatively, a second sensor block (e.g., a thermal sensor) can: generate a set of thermal scans in Block S146; derive a set of human movement profiles from the set of thermal scans; aggregate the set of thermal scans into a composite thermal scan excluding personally identifiable information; and transmit the composite thermal scan to the remote computer system. The remote computer system can: receive the composite thermal scan; derive a set of locations of humans in the space based on set of human movement profiles in the composite thermal scan; access the synthetic photographic image of the space; annotate the synthetic photographic image of the space with the set of locations of humans in the space to generate an anonymized synthetic photographic image representing occupancy of the space; and transmit the anonymized synthetic photographic image of the space to the operator portal.

In one implementation, the remote computer system can: detect presence (or absence) of humans for a particular region of a space (e.g., a conference room); derive occupancy of the region of the space; and accordingly update a scheduler associated with the region.

In particular, the first sensor block can: capture the first image of the space including a conference room during a first time period; capture a second non-optical image of the space during a second time period in Block S140; and transmit the second non-optical image of the space to the remote computer system in Block S142. In response to receiving the second image, the remote computer system can: identify absence of humans in the second image in Block S154; and, in response to detecting absence of humans in the second image, identify the conference room as available and update a conference room scheduler to indicate the conference room as available in Block S156.

Additionally or alternatively, in response to receiving the second image, the remote computer system can: identify presence of humans in the second image; and, in response to detection of presence of humans in the second image, identify the conference room as occupied and update a conference room scheduler to indicate the conference room as unavailable.

Additionally or alternatively, the first sensor block can: capture a second image (e.g., radar scan) of the space during a second time period; implement methods and techniques as described herein to detect presence of humans in the conference room based on human movement profiles; and, in response to detecting absence of humans in the second image, identify the conference room as available and update a conference room scheduler to indicate the conference room as available.

Similarly, the first sensor block can: capture a second image (e.g., radar scan) of the space during a second time period; implement methods and techniques as described herein to detect presence of humans in the conference room based on human movement profiles; and, in response to detecting presence of humans in the second image, identify the conference room as occupied and update a conference room scheduler to indicate the conference room as unavailable.

Accordingly, in the foregoing examples, the sensor block and remote computer system can coordinate to: derive or predict occupancy of a space (e.g., conference room, workstation) based on radar scans captured by the sensor block; and update schedulers and/or transmit occupancy data to an operator portal.

In one example, each sensor block can populate points, representing a location of the object, in a radar scan with a color value to represent motion “hot spots” of the object in subregions in the particular region of the space.

In one implementation, each sensor block: generates a set of radar scans representing human movement profiles—such as hot spots frequently occupied by humans moving in the region within the field of view of the sensor block—annotated with velocities, locations, and/or orientations of humans in a two-dimensional cartesian coordinate system or a three-dimensional spherical coordinate system; annotates individual points (or pixels) in each radar scan with a color value representing a height (e.g., an elevation angle) of the pixel in a two-dimensional or three-dimensional representational space of this region; aggregates the set of radar scans into a composite radar scan, such as a two-dimensional or three-dimensional point cloud, of this region of the space; and transmits the composite radar scan to the computer system. The remote computer system can then stitch composite radar scans from the set of sensor blocks deployed in the space and store locations of the set of sensor blocks into a map of the space.

In one variation, each sensor block: generates a set of radar scans representing human movement profiles—such as hot spots frequently occupied by humans moving in the region within the field of view of the sensor block—annotated with velocities, locations, and/or orientations of humans in a three-dimensional spherical coordinate system; annotates individual data points (e.g., echoes or returns) in each radar scan with a color value representing a height (e.g., an elevation angle) of the data point in a three-dimensional representational space to form a heatmap of this region; aggregates the set of radar scans into a three-dimensional point cloud of this region of the space; and transmits the three-dimensional point cloud to the computer system. The remote computer system then combines three-dimensional point clouds from the set of sensor blocks deployed in the space and stored locations of the set of sensor blocks into a map of the space.

### 7.2.2 Human Movement Profiles+Occupancy

In one variation, the remote computer system can derive occupancy data based on human movement profiles and/or predict occupancy for a space based on directions associated with these human movement profiles.

In one example, the sensor block can include a threshold sensor configured to capture a set of entry events and a set of exit events representing humans entering and exiting the space (or a region of the space defined by a threshold). In this example, the sensor block can: access the set of entry events and the set of exit events from the threshold sensor; access the set of human movement profiles, each human movement profile defining a direction vector; fuse the set of entry events, the set of exit events, and the set of human movement profiles; validate the set of exit events based on direction vectors associated with human movement profiles; estimate a current occupancy of the space based on the set of entry events and the set of exit events; and predict a future occupancy of the space based on the set of entry events and the set of exit events, and direction vectors associated with human movement profiles indicating imminent entry and/or exit events.

In particular, the sensor block can, in response to detecting absence of an exit event and in response to detecting a direction of a first human movement profile indicative of imminent exit, predict an exit event for the first human and update an occupancy count accordingly (e.g., −1).

Additionally or alternatively, the remote computer system can: receive the set of entry events and the set of exit events; receive the set of human movement profiles, each human movement profile defining a direction vector; estimate a current occupancy of the space based on the set of entry events and the set of exit events; and predict a future occupancy of the space based on the set of entry events and the set of exit events, and direction vectors associated with human movement profiles indicating imminent entry and/or exit events.

Accordingly, in the foregoing examples, the remote computer system and/or population of sensor blocks can predict future occupancy of the space based on imminent threshold (e.g., entry, exit) events according to directions of human movement derived from human movement profiles.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
at a first sensor block:
capturing a first image of a space;
detecting a constellation of edges in the first image, the constellation of edges representing a set of objects in the space;
assembling the constellation of edges into an edge map; and
serving the edge map to a remote computer system; and
at the remote computer system:
receiving the edge map from the first sensor block;
accessing a model configured to transform edge maps into synthetic photographic images representing locations of objects;
executing the model to transform the edge map into a synthetic photographic image depicting synthetic photographic representations of the set of objects and the space; and
serving the synthetic photographic image to an operator portal for an operator to view an anonymized layout of the space.

2. The method of claim 1:
wherein capturing the first image of the space comprises capturing a first radar scan of the space;
wherein assembling the constellation of edges into the edge map comprises assembling the constellation of edges into the edge map comprising a vectorized representation of the first radar scan; and
wherein executing the model to transform the edge map into the synthetic photographic image comprises executing the model to transform the edge map into a synthetic photographic image comprising a two-dimensional photographic image.

3. The method of claim 1:
wherein capturing the first image of the space comprises capturing a first greyscale photographic image of the space;
wherein assembling the constellation of edges into the edge map comprises assembling the constellation of edges into the edge map comprising a vectorized representation of the first greyscale photographic image; and
wherein executing the model to transform the edge map into the synthetic photographic image comprises executing the model to transform the edge map into a synthetic photographic image comprising a two-dimensional color photographic image.

4. The method of claim 1:
wherein capturing the first image of the space comprises capturing the first image of the space depicting:
a first wall surface characterized by a first color pattern; and
a first desk characterized by a first geometry;
wherein detecting the constellation of edges in the first image comprises:
detecting a first subset of edges of the first wall surface; and
detecting a second subset of edges of the first desk;
wherein assembling the constellation of edges into the edge map comprises assembling the constellation of edges into the edge map comprising the first subset of edges and the second subset of edges; and
further comprising, at the model:
interpreting a first wall surface object from the first subset of edges in the edge map;
retrieving a stored wall surface pattern associated with wall surface objects and approximating the first color pattern;
generating a first synthetic photographic representation of the first wall surface object characterized by the stored wall surface pattern;
interpreting a first desk object from the second subset of edges in the edge map;
retrieving a stored desk geometry associated with desk objects and approximating the first geometry; and
assembling the first synthetic photographic representation of the wall surface object and the second synthetic photographic representation of the first desk object into the synthetic photographic image.

5. The method of claim 1:
wherein capturing the first image of the space comprises capturing the first image of the space depicting:
a first wall surface characterized by a first color pattern; and
a first desk characterized by a first geometry;
wherein detecting the constellation of edges in the first image comprises:
detecting a first subset of edges of the first wall surface; and
detecting a second subset of edges of the first desk;
wherein assembling the constellation of edges into the edge map comprises assembling the constellation of edges into the edge map comprising the first subset of edges and the second subset of edges; and
further comprising, at the model:
interpreting a first wall surface object from the first subset of edges in the edge map;
generating a first synthetic photographic representation of the first wall surface object characterized by a second color pattern different from the first color pattern;
interpreting a first desk object from the second subset of edges in the edge map;
generating a second synthetic photographic representation of the first desk object characterized by a second geometry different from the first geometry; and
assembling the first synthetic photographic representation of the wall surface object and the second synthetic photographic representation of the first desk object into the synthetic photographic image.

6. The method of claim 5:
wherein capturing the first image of the space comprises capturing the first image of the space depicting a first human characterized by a third geometry;
wherein detecting the constellation of edges in the first image comprises detecting a third subset of edges of the first human;
wherein assembling the constellation of edges into the edge map comprises assembling the constellation of edges into the edge map comprising the third subset of edges; and
further comprising, at the model:
interpreting a first human object from the third subset of edges in the edge map;
generating a third synthetic photographic representation of the first human object characterized by a fourth geometry different from the third geometry; and
assembling the third synthetic photographic representation of the first human into the synthetic photographic image.

7. The method of claim 1:
wherein capturing the first image of the space comprises capturing the first image of the space depicting:
a first object of a first object type; and
a second object of a second object type;
wherein detecting the constellation of edges in the first image comprises:
detecting a first subset of edges of the first object;
annotating the first subset of edges with the first object type;
detecting a second subset of edges of the second object; and
annotating the second subset of edges with the second object type;
wherein assembling the constellation of edges into the edge map comprises assembling the constellation of edges into the edge map comprising the first subset of edges and the second subset of edges; and
further comprising, at the model:
retrieving a first object representation of the first object type;
generating a first synthetic photographic representation of the first object characterized by the first object representation;
retrieving a second object representation of the second object type;
generating a second synthetic photographic representation of the second object characterized by the first object representation; and
assembling the first synthetic photographic representation of the first object and the second synthetic photographic representation of the second object into the synthetic photographic image.

8. The method of claim 1:
wherein capturing the first image of the space comprises capturing the first image of the space during a first time period; and
further comprising:
during a second time preceding the first time period:
accessing a first training image from the first sensor block;
detecting a first object of a first object type from the first training image;
extracting a first set of visual characteristics of the first object; and
storing the first set of visual characteristics for the first object type in the space; and
during a third period following the second time period:
accessing a second image of the space captured by the first sensor block;
detecting a second constellation of edges in the second image, the second constellation of edges representing a second set of objects in the space;
detecting a second object of the first object type in the second constellation of edges;
accessing the first set of visual characteristics of the first object type;
generating a first synthetic photographic representation of the second object characterized by the first set of visual characteristics; and
assembling the first synthetic photographic representation of the first object into the synthetic photographic image.

9. The method of claim 1, further comprising:
at a second sensor block comprising a radar sensor and defining a second field of view intersecting the space:
capturing a series of radar scans;
interpreting a set of paths of humans moving within the space from the series of radar scans; and
serving the set of paths to the remote computer system; and
at the remote computer system:
overlaying the set of paths onto the synthetic photographic image to generate an anonymized synthetic occupancy animation; and
serving the anonymized synthetic occupancy animation to the operator portal.

10. The method of claim 1 further comprising:
at a second sensor block comprising a thermal sensor and defining a second field of view intersecting the space:
capturing a series of thermal scans;
interpreting a set of paths of humans moving within the space from the series of thermal scans; and
serving the set of paths to the remote computer system; and
at the remote computer system:
overlaying the set of paths onto the synthetic photographic image to generate an anonymized synthetic occupancy animation; and
serving the anonymized synthetic occupancy animation to the operator portal.

11. The method of claim 1:
wherein capturing the first image of the space at the first sensor block comprises capturing the first image of the space at the first sensor block during a first time period; and
further comprising, during a second time period succeeding the first time period:
at the first sensor block:
capturing a second image of the space;
detecting a second constellation of edges in the second image, the second constellation of edges representing objects in the space;
assembling the second constellation of edges into a second edge map; and
serving the second edge map to the remote computer system; and
at the remote computer system:
receiving the second edge map;
passing the second edge map to the model;
receiving a second synthetic photographic image of the space from the model, the second synthetic photographic image representing locations of objects in the space;
detecting a difference between the first synthetic photographic image and the second synthetic photographic image;
annotating the difference in the second synthetic photographic image; and
serving the second synthetic photographic image to the operator portal.

12. The method of claim 1:
wherein capturing the first image of the space comprises, at the first sensor block, capturing the first image of the space comprising a conference room; and
further comprising, at the remote computer system:
in response of absence of humans in the synthetic photographic image:
identifying the conference room as unoccupied; and
updating a conference room scheduler to indicate the conference room as available.

13. The method of claim 1:
wherein capturing the first image of the space comprises capturing the first image depicting a first region of the space at the first sensor block defining a first field of view comprising the first region;
wherein detecting the constellation of edges in the first image comprises detecting the constellation of edges representing objects in the first region of the space;
wherein receiving the synthetic photographic image of the space from the model comprises receiving the synthetic photographic image representing locations of objects in the first region of the space;
further comprising:
at a second sensor block defining a second field of view comprising a second region intersecting the first region:
capturing a second image of the space, the second image depicting the second region of the space;
detecting a second constellation of edges in the second image, the second constellation of edges representing a second set of objects in the space;
assembling the second constellation of edges into a second edge map; and
serving the second edge map to a remote computer system; and
at the remote computer system:
receiving the second edge map from the second sensor block;
accessing the model configured to transform edge maps into synthetic photographic images representing locations of objects;
executing the model to transform the second edge map into a second synthetic photographic image depicting synthetic photographic representations of the second set of objects and the second region; and
assembling the first synthetic photographic image and the second synthetic photographic image into a composite synthetic photographic image representing objects in the first region and the second region of the space; and
wherein serving the synthetic photographic image to the operator portal comprises serving the composite synthetic photographic image to the operator portal for the operator to view the anonymized layout of the first region and the second region of the space.

14. The method of claim 13, wherein assembling the first synthetic photographic image and the second synthetic photographic image into the composite synthetic photographic image comprises assembling the first synthetic photographic image and the second synthetic photographic image into the composite synthetic photographic image comprising a three-dimensional isometric representation of the space.

15. A method comprising:
at a first sensor block, in a population of sensor blocks, deployed in a space:
capturing a first set of images of the space;
for each image in the set of images:
detecting a constellation of edges representing a set of objects in the space; and
assembling the constellation of edges into an edge map in a set of edge maps; and
serving the set of edge maps to a remote computer system; and
at the remote computer system:
assembling the set of edge maps into a composite edge map;
transforming the composite edge map into a synthetic photographic image depicting synthetic photographic representations of the set of objects and the space; and
serving the synthetic photographic image to an operator portal for an operator to view an anonymized layout of the space.

16. The method of claim 15:
wherein capturing the first set of images of the space comprises capturing a first set of radar scans of the space;
wherein assembling the constellation of edges into the edge map comprises assembling the constellation of edges into the edge map comprising a vectorized representation of a first radar scan; and
wherein transforming the composite edge map into the synthetic photographic image depicting synthetic photographic representations of the set of objects and the space comprises:
accessing a model configured to transform edge maps into synthetic photographic images representing locations of objects; and
executing the model to transform the composite edge map into the synthetic photographic image comprising a two-dimensional photographic image.

17. The method of claim 15:
wherein capturing the first set of images of the space comprises capturing a first image of the space depicting a first human defined by a first geometry;
wherein detecting the constellation of edges representing the set of objects in the space comprises, for the first image, detecting a first subset of edges of the first human based on the first set of visual characteristics;
wherein assembling the constellation of edges into the edge map in the set of edge maps comprises, for the first image, assembling the constellation of edges into the edge map comprising the first subset of edges; and
further comprising, at the remote computer system:
interpreting a first human object from the first subset of edges in the edge map;
generating a first synthetic photographic representation of the first human object characterized by a second geometry different from the first geometry; and
assembling the first synthetic photographic representation of the first human into the synthetic photographic image.

18. The method of claim 15:
wherein capturing the first set of images of the space at the first sensor block comprises capturing a first image of the space at the first sensor block during a first time period;
further comprising:
at the first sensor block during a second time period preceding the first time period:
capturing a set of training images of the space;
for each image in the set of training images:
detecting a second constellation of edges representing objects in the space; and
assembling the second constellation of edges into a training edge map in a set of training edge maps; and
serving the set of training edge maps and the set of training images to the remote computer system; and
at the remote computer system:
receiving the set of training edge maps and the set of training images from the first sensor block; and
training a model, according to the set of training edge maps and the set of training images, to output synthetic photographic images representing locations of objects based on edge maps; and
wherein transforming the composite edge map into the synthetic photographic image depicting synthetic photographic representations of the set of objects and the space comprises:
accessing the model configured to transform edge maps into synthetic photographic images representing locations of objects; and
executing the model to transform the composite edge map into the synthetic photographic image.

19. The method of claim 15, further comprising:
at the first sensor block:
detecting a set of textures in a first image in the set of images;
assembling the set of textures into a texture map; and
serving the texture map to the remote computer system; and
at the remote computer system, transforming the texture map into the synthetic photographic image representing textures of objects within a field of view of the first sensor block.

20. A method comprising:
at a first sensor block:
capturing a first image of a space;
detecting a constellation of edges in the first image, the constellation of edges representing edges of objects in the space;
assembling the constellation of images into an edge map; and
serving the edge map to a remote computer system; and
at the remote computer system during a first time period:
receiving the edge map from the first sensor block;
generating a synthetic photographic image of the space based on the edge map, the synthetic photographic image representing locations of objects in the space; and
serving the synthetic photographic image to an operator portal for an operator to view an anonymized layout of the space.
